(19) United States
(12) Patent Application Publication
(10) Pub. No.: US 2022/0294255 A1
(43) Pub. Date: Sep. 15, 2022

(54) MOBILE SMARTPHONE CHARGING SYSTEM

(71) Applicant: Lexin Electronics Co., LTD, Costa Mesa, CA (US)

(72) Inventor: Anthony Livano, MIssion Viejo, CA (US)

(73) Assignee: Lexin Electronics Co., LTD, Costa Mesa, CA (US)

(21) Appl. No.: 17/763,637

(22) PCT Filed: Sep. 25, 2020
(86) PCT No.: PCT/US20/52910

§ 371 Date: Mar. 24, 2022

Related U.S. Application Data
(60) Provisional application No. 62/905,991, filed on Sep. 25, 2019.

(51) Int. Cl. H02J 7/00; H02J 50/10; H02J 7/04

(52) U.S. Cl. CPC H02J 7/007192; H02J 50/10; H02J 7/04

(57) ABSTRACT

A method and apparatus are provided for charging mobile devices such as smartphones and tablets. One of the most critical aspects in the performance of smartphones and other communications devices is the duration of available standby time during which the device will be operational, assuming that no communications are executed, and talk time which is the time during which a device may be used to implement a duplex audio communication function such as a voice telephone call to another smartphone. Both these functions depend upon battery performance.

### CROSS REFERENCE TO RELATED APPLICATIONS

This application claims the benefit of Provisional Patent Application No. 62/905,991, filed on Sep. 25, 2019, entitled Mobile Smartphone Charging System” the disclosure of which is hereby incorporated herein by reference thereto.

### TECHNICAL FIELD

The invention relates to apparatus and methods for charging smartphones, tablets, and other mobile devices during transit to minimize the likelihood of dangerous conditions such as overheating, catching fire, or the like, especially when in mobile use, such as when such devices are stowed on a moving motorcycle or other vehicle.

### BACKGROUND OF THE INVENTION

Smartphones are a key component of modern life. So much so, that many panic when the low battery notification inevitably arises. Keeping a phone charged throughout the day while on the go has been a challenge for many years and is not easily overcome.

One way of charging on the go can be accomplished by diverting some power from one's transportation vehicle. For convenience cell phone mounts are used to secure the user's phone for easy viewing and accessibility. Mounts, such as the ram mount (https://www.rammount.com/consumer/device-mounts/phone-mounts), are well known in the art, however, there is an inconvenience factor when it comes to phone plugs.

Every time a user wants to charge their phone, they need to scramble around looking for the plug, in or on their vehicle, confirm that the plug is oriented correctly, and risk damaging their phone's connector while in a rush. Furthermore, cell phone plugs, generally, have a tendency to bend and twist to the point of destroying the wiring necessary for effectively charging the user's phone.

Wireless chargers, some sold under the Qi trademark, are and have been widely used. However, there is a pivotal issue with such chargers causing them to overheat, reducing their charging capabilities, damaging the charger, and potentially harming the user's phone.

Therefore, there is a need for a wireless charger system that not only prevents overheating but, in a situation, where it does overheat, that there are safeguards in place to avoid damaging the user's phone.

### SUMMARY OF THE INVENTION

Notwithstanding the fact that people have been dealing with the problem of keeping a smartphone or other portable telecommunications device charged for going on for over three decades, an effective mobile solution has not been devised. While most users, in the context of driving an automobile, routinely plug an adapter into a cigarette lighter socket or use a provided USB port, the solution is hardly ideal, placing stress and increasing the likelihood of an accident as the driver bumbles to plug the cord into the cell phone and into the charging device. In the case of a motorcycle, that approach would be completely unmanageable.

In accordance with the invention, these issues are effectively addressed. More particularly, the invention provides a method and apparatus for charging mobile devices such as smartphones and tablets. One of the most critical aspects in the performance of smartphones and other communications devices is the duration of available standby time during which the device will be operational, assuming that no communications are executed, and talk time which is the time during which a device may be used to implement a duplex audio communication function such as a voice telephone call to another smartphone. Both these functions depend upon battery performance.

An apparatus is disclosed for charging a cellular telephone including an inductive coupling member. An electronic charging circuit is physically separated from the inductive coupling member by a cable. A heat sensor is associated physically with the inductive coupling member. The heat sensor provides a control output to the electronic charging circuit. The electronic charging circuit moderates or terminates charging in response to the detection of an excessive temperature or the onset of an excessive temperature by the heat sensor. A coupling cable connected to the electronic charging circuit couples the electronic charging circuit to a source of power.

Optionally, the electronic starting circuit includes a heat reducing circuit and an alternating current generating circuit. The heat reducing circuit and the alternating current generating circuit may be each optionally contained in its own respective housing. The heat reducing circuit and alternating current generating circuit may be coupled to each other by cable.

### BRIEF DESCRIPTION OF THE DRAWINGS

The operation of the inventive system will become apparent from the following description taken in conjunction with the drawings, in which:

FIG. 1 is a schematic plan view of the inventive charger;

FIG. 2 is an exploded perspective view of the inventive inductive primary component of a charger showing its relationship to a conventional smartphone holder when in use in accordance with the invention;

FIG. 3 is a bottom exploded perspective view of the housing component of a charger in accordance with the invention; and

FIG. 4 is a schematic perspective of the inventive system.

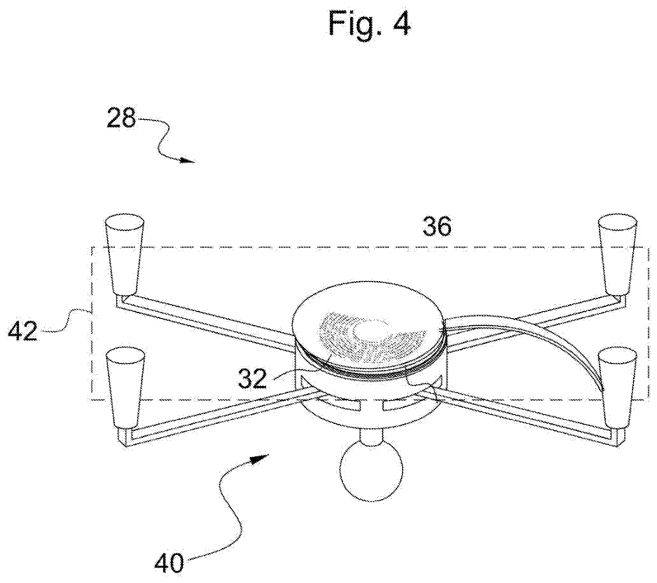

### DETAILED DESCRIPTION OF THE PREFERRED EMBODIMENTS

The duration of 1) available standby time during which the device will be operational, assuming that no communications are executed, and 2) talk time which is the time during which a device may be used to implement a duplex audio communication function, such as a voice telephone call to another smartphone. Both of these functions depend upon battery performance.

Overall battery performance in the context of longevity during use is properly described by a complex set of parameters, including capacity in mAh, charging time, temperature during charging, and so forth. In addition, the picture is complicated by the possibility of charging during use and variability of standby and talk associated battery consumption in between charging times. Still, another factor is the possibility of damage from overheating and/or a battery catching fire during charging. Permanent changes of the battery during such events, the onset of such events or changes in the battery prior to the onset of such events, further complicate the picture.

In accordance with the invention, it has been recognized that system performance may be ameliorated by varying charging parameters. More particularly, it has been discovered that the above problems are advantageously addressed by introducing particular features into the mechanical structure of certain types of apparatus used for charging the mobile device.

Qi trademark type charging is now a popular way to charge devices. It has the advantage of eliminating the possibility of mechanical stresses eventually causing charging cable receiving jacks on the smartphone or other mobile devices to deteriorate over time. This is achieved because charging is done without any mechanical contact with the charging port on the telephone. Instead, the mobile device is provided with a secondary charge receiving coil which is inductively coupled to a charging coil connected to an appropriate power supply. The power supply generally comprises a cable which connects to the battery on the motorcycle to receive 12 V DC power. The power supply outputs an alternating current signal which allows for efficient and continuous inductive coupling. The nature of the alternating current generating circuitry and inductive coupling components on the charger and within the mobile devices are of conventional design and will not be described here.

In the prior art, recharging is achieved with a first circuit which converts the current from the battery to a lower voltage, such as a voltage in the range of 5 V to 9 V, with the circuit outputting the lower voltage as an alternating current to the inductive charging system primary coil. These circuits are all contained within a single housing which is adhered to the face of a spring-based smartphone or mobile device holding device which is secured to, for example, the handlebars of a motorcycle by a ball and socket mounting attached to the handlebars.

During charging heat tends to be produced by the circuitry, and this circuitry becomes hot. Because it is in contact with the back of the smartphone, the heated charging circuitry tends to heat the smartphone, with attendant deterioration of the smartphone battery and increasing the likelihood of damage to the battery or potentially ignition of a fire.

In accordance with the invention, it has been discovered that separating the charging circuitry into a first component which converts the current from the battery to a lower voltage, such as a voltage in the range of 5 V to 9 V, a physically separate second mechanically separated component providing overload protection and optionally for changing that lower voltage to an alternating current, and a third physically separate component comprising the primary of the inductive charging system.

Because they are physically separate, the first component which is reducing the voltage from the motorcycle battery to a voltage suitable for charging a smartphone dissipates its heat to the surrounding air without conducting it to other elements or the smartphone.

Likewise, the second component also dissipates its heat to the surrounding air instead of conducting it to the smartphone being charged through the inductive primary of the charging system.

Finally, the inductive primary generates little or no heat and, accordingly, its being in contact with the back of the smartphone does not result in any deterioration or dangerous condition.

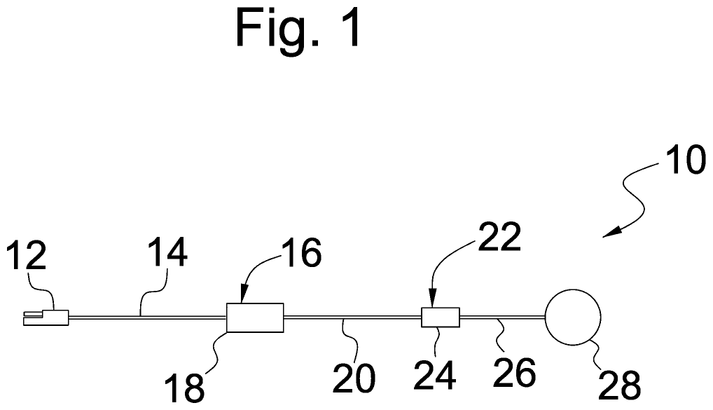

Turning to FIG. 1, the operation of the inventive charger 10 may be understood. Generally, charger 10 comprises a jack 12 which allows devices to be connected to the battery of, for example, a motorcycle. Jack 12 is coupled by cable 14 to a voltage reduction circuit 16. The electronic configuration of voltage reduction circuit 16 is conventional in nature. However, voltage reduction circuit 16 is contained in its own housing 18 which is exposed to ambient air on all sides. It is noted that when the device is used on a motorcycle, such ambient air is rapidly flowing around housing 18, providing highly effective cooling of the circuit.

Voltage reduction circuit 16 is, in turn, coupled by a cable 20 to an overload prevention circuit 22, which may be of conventional design from the standpoint of its electronic circuitry. However, overload prevention circuit 22 also is contained within its own housing 24. Here again, the housing is exposed to the air allowing the dissipation of heat generated by the electronic circuitry to the surrounding ambient air. This, again, is rendered particularly effective in so far as in the case of a motorcycle, the air is moving very rapidly around housing 24, particularly at high speeds of travel, resulting in efficiently dissipating heat.

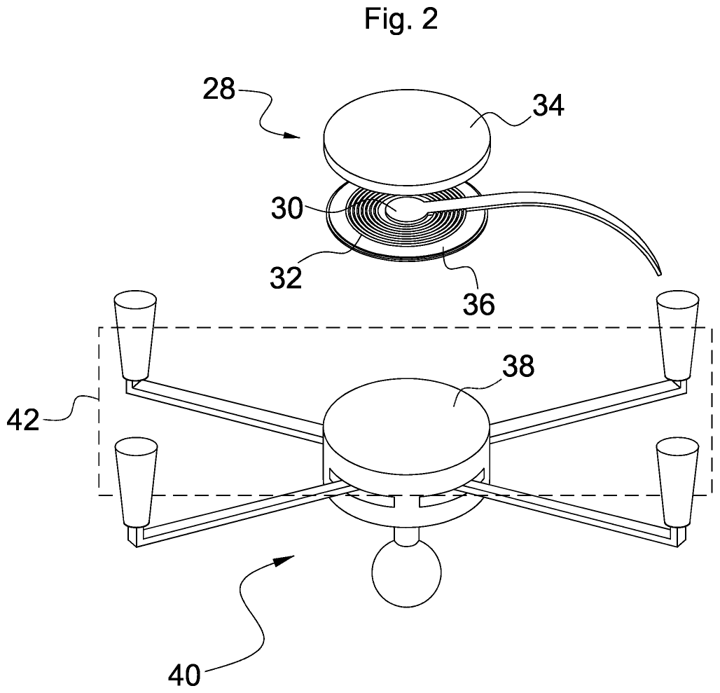

Overload prevention circuit 22 is coupled by cable 26 to a wireless inductive primary component 28. Wireless inductive primary component 28 comprises a heat sensing device 30, as illustrated in FIG. 2.

If heat sensing device 30 determines that the cell phone has become too hot, charging is optionally moderated or terminated.

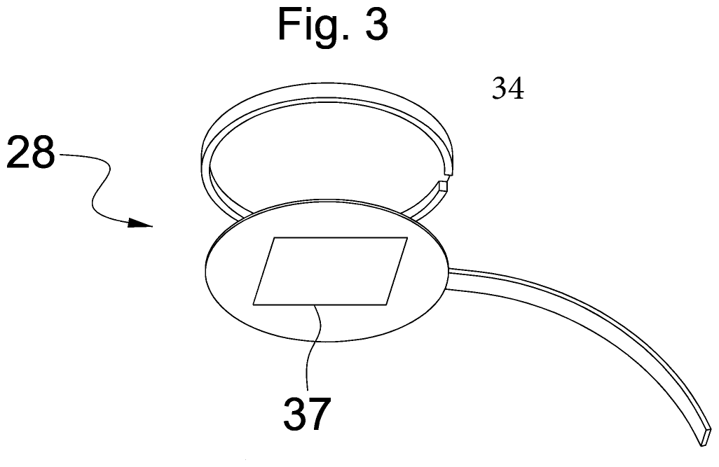

Inductive primary component 28 also includes a primary induction coil 32 of conventional design which is held between a pair of housing members 34 and 36 which are adhered to each other. On the other side of housing component 36, a double stick adhesive member 37 (FIG. 3) is provided for adhering inductive primary component 28 to the base of a mobile device holding mounting 38.

When the overload prevention circuit 22 determines that there is an overload condition, it moderates or, if necessary, shuts down the charging operation.

Because inductive primary component 28 does not generate any substantial heat, it does not heat smartphone 42 when the smartphone is placed within the cradle 40 of mobile device holding mounting 38.

While illustrative embodiments of the invention have been described, it is noted that various modifications will be apparent to those of ordinary skill in the art in view of the above description and drawings. Such modifications are within the scope of the invention which is limited and defined only by the following claims.

What is claimed:

1. Apparatus for charging a cellular telephone, comprising:
(a) inductive coupling member;
(b) electronic charging circuit physically separated from said inductive coupling member by a cable;
(c) a heat sensor associated physically with said inductive coupling member, said heat sensor providing a control output to said electronic charging circuit, said electronic charging circuit moderating or terminating charging in response to the detection of an excessive temperature onset smartphone by said heat sensor; and
(d) a coupling cable connected to said electronic charging circuit to couple said electronic charging circuit to a source of power.

2. Apparatus as in claim 1, wherein the electronic starting circuit comprises a heat reducing circuit and an alternating current generating circuit, said heat reducing circuit and said alternating current generating circuit is contained in its own respective housing, said heat reducing circuit and said alternating current generating circuit being coupled to each other by cable.
